(19) United States
(12) Patent Application Publication
(10) Pub. No.: US 2008/0100792 A1
(43) Pub. Date: May 1, 2008

(54) Universal endpiece for spectacle temples

(76) Inventors: Ronald D. Blum, Roanoke, VA (US); William Kokonaski, Gig Harbor, WA (US); Dwight P. Duston, Laguna Niguel, CA (US); Ian Shakil, Coral Springs, FL (US); Nelson Roos, Baltimore, MD (US); Charlotte Hanks, Oak Ridge, NC (US); Daniel Lentz, Blacksburg, VA (US); Bridget Barry, McLean, VA (US); Elizabeth Groeger, New York, NY (US); Martin Riofrio, Lima (PE)

Correspondence Address: Pearl Cohen Zedek Latzer, LLP, 1500 Broadway, 12th Floor, New York, NY, 10036, US

(21) Appl. No.: 11/976,199

(22) Filed: Oct. 22, 2007

Related U.S. Application Data
(60) Provisional application No. 60/854,677, filed on Oct. 27, 2006.
(60) Provisional application No. 60/854,697, filed on Oct. 27, 2006.

(51) Int. Cl. G02C 11/00; G02C 7/10

(52) U.S. Cl. 351/44; 351/158

(57) ABSTRACT

This invention relates to temples or end-pieces of temples for eyeglass frames. The temples are disclosed as having a wide variety of electrical and/or electronic components housed therein. Temples and hinges are also disclosed which attach to either the eyeglass frame itself or to the surface of a lens and which break apart from its attachment upon an impact without damage to the temple, the hinge, the frame, or the surface of the lens. A hinge is also disclosed for connecting a temple having a power source to an eyeglass frame and for providing an electrical connection with the frame only when the temple is opened.

### CROSS REFERENCE TO RELATED APPLICATIONS

This application claims the benefit of U.S. Ser. No. 60/854,677, filed on Oct. 27, 2006 (and entitled Universal Temple End-Piece (UTEP) For Spectacles), and U.S. Ser. No. 60/854,697, also filed on Oct. 27, 2006 (and entitled Advanced Electronic Eyewear), both of which are incorporated in their entirety herein by reference.

### BACKGROUND OF THE INVENTION

1. Field of the Invention

The present invention generally relates to eyewear, including (but not limited to) prescription eyeglasses, electro-active eyewear, protective/safety eyeglasses, sunglasses, heads-up-display-containing eyewear, virtual-reality-goggles, 3-D visors, and the like. All of these eyewear embodiments involve the use of a spectacle frame that rests upon a wearer's ears and nose for the purpose of augmenting or protecting the wearer's vision. This invention specifically relates to the temple pieces of the spectacle frame. It more specifically relates to the temple end-pieces, sometimes referred to as the tips of the temples.

This invention applies to both electrical eyewear and to conventional (non-electrical) eyewear. We define electrical eyewear as any eyewear that includes a power source (e.g. a battery), communication components (e.g. speakers, ear buds, wireless networking components), microelectronics, transducers, memory, and/or the like. Strands of wire bundles or conductive materials may be typically embedded within the frame to permit such electrical components to communicate and to share power. We define non-electrical eyewear as eyewear that makes no use of such electrical components. Non-electrical eyewear is purely mechanical and optical. Examples of non-electrical eyewear include prescription eyeglasses and sunglasses.

The term “UTEP” is merely a short hand term used throughout this patent application and no special significance should be attributed to this acronym. By using the temple end piece in accordance with this invention, an affordable mass production of UTEPs may be made compatible with an assortment of different frames. Moreover, it may now be possible to discreetly house these heavy and unsightly components on the over-and-behind-the-ear portion of the frame (where the UTEP lies) rather than on another frame-based location with heretofore unrealized results.

2. Description of the Related Art

The miniaturization of semiconductor chips, sophisticated earphones, non-volatile solid-state memory devices, and wireless communication capabilities (including blue tooth, and other short-range wireless technologies) have ushered a revolution in personal electronic components and audio listening devices that allows wearers to listen to music in a portable, hands-free manner. In addition, recent research and development has resulted in the development of accessories and features for eyeglasses such as, by way of example only: electro-active spectacle lenses which provide the wearer with variable focus capability, electro-active spectacle lenses that allow for a varying index matrix needed to correct higher order aberrations to create a super-vision effect, electronic heads up displays that are associated with eye glasses, electro-chromic lenses that change color and tint by way of electrical activation, and also the addition of audio and communication systems that are associated with eyeglasses.

It is increasing apparent that the eyeglass frame is also becoming a platform for associating and housing various electronic accessories. Currently, there is no known way to electrify the eyeglass frame in a manner that provides a combination of pleasing aesthetics, comfort, convenience, and also allows for the proper ergonomics. While comfort, convenience and ergonomics are important, the proper fashion look of the eyeglass frame is what takes priority when the consumer makes a purchase decision. There is therefore a great need in the art for new electronic eyeglass applications that are convenient and comfortable to use and which are also an aesthetically pleasing way to provide power to the eyeglass frame and lenses.

Accordingly, there is now provided with this invention an improved temple design for eyeglass frames which addresses and corrects this pressing need. The invention does this in a manner that allows for the eyeglass frames to continue to appear like conventional fashionable eye glass frames whether they be dress glasses, sport glasses, security glasses, sunglasses, or goggles. It also takes the added weight of the power source off of the eyeglass frame and places this weight where it is barely noticed. Finally, it provides for doing this in a most ergonomic and convenient manner.

### SUMMARY OF THE INVENTION

According to one aspect of the invention, an end-piece for a temple of an eyeglass frame is disclosed. The end-piece is adapted for attaching to either the right temple or the left temple of the eyeglass frame. The end-piece comprises an attachment device for detachably attaching the end-piece to the temple of the eyeglass frame and an electronic component housed therein.

Another aspect of the invention is directed to a temple of an eyeglass frame. The temple comprises an attachment device for attaching to a surface of a lens and an electronic component housed therein. The attachment device provides an electrical connection between the temple and said lens.

A further aspect of the invention is directed to a hinge for connecting a temple having an electronic component housed therein to an eyeglass frame. The hinge comprises an attachment device for attaching to the temple of the eyeglass frame and the attachment device is adapted for detachment from the frame upon impact thereto without damage to the frame or the temple. Alternatively, a hinge is disclosed for connecting a temple to a surface of a lens. The hinge comprises an attachment device for attaching to the surface of a lens and an electronic component housed therein. The attachment device is adapted for detachment upon impact thereto without damage to the lens or the temple.

A still further aspect of the invention is directed to a hinge for connecting a temple having a power source to an eyeglass frame. The hinge is adapted for providing an electrical connection with the frame only when the temple is opened. Alternatively, the hinge may be for connecting a temple to a surface of a lens. The temple includes a power source and the hinge comprises an electronic component connected to the power source. The hinge is adapted for providing an electrical connection with the lens only when the temple is opened.

In each of these embodiments, the temple or the hinge may provide a variety of additional electronic components and features. These may include, for example, an attachment device that includes a snap-on device, or a screw, or a squeezing device for detachably attaching the end-piece to the temple, or a magnet. The electronic component may include a power source, or a tilt switch, or a listening device, or a docking station for an additional electronic component, or a charging device. The charging device may be adapted for directly or indirectly coupling to an energy source. The temple or the hinge or the end-piece may be adapted for providing an electrical connection with the frame only when the frame is opened and the end-piece may be capable of attaching to a plurality of different temples each capable of receiving the end-piece.

The frame to which either the end-piece or the hinge is connected may house an electro-active lens and the lens may be capable of having its tint altered by electrical power. The hinge may directly connect to the lens which has electrical contact points thereon for mating with said attachment device.

As will be appreciated by those persons skilled in the art, a major advantage provided by the present invention is a universal end-piece for connecting to the end of either temple of an eyeglass frame that may house a variety of electronic components. It is another object of the invention to provide a hinge to either a frame or a lens that may detach upon impact without damaging either the hinge or the temple, frame, or lens to which the hinge is attached. It is a still further object of the invention to provide contacts on a surface of a lens to which a hinge or a temple may be electrically attached. Additional objects of the present invention will become apparent from the following description.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is a drawing showing a temple end-piece of the present invention.

FIG. 2 is an enlarged drawing showing a temple end-piece of the present invention.

FIG. 3a is one embodiment of the temple end-piece of the present invention depicting one form of attachment to a temple of a spectacle frame.

FIG. 3b is another embodiment of the temple end-piece of the present invention depicting an alternative form of attachment to a temple of a spectacle frame.

FIG. 3c is another embodiment of the temple end-piece of the present invention depicting an alternative form of attachment to a temple of a spectacle frame.

FIG. 3d is another embodiment of the temple end-piece of the present invention depicting an alternative form of attachment to a temple of a spectacle frame.

FIG. 4 is a drawing showing an embodiment for charging a battery in the temple of a spectacle frame.

FIG. 5 is a drawing showing another embodiment for charging a battery in the temple of a spectacle frame.

FIG. 6a shows a wearer of an embodiment of the temple end-piece of the present invention.

FIG. 6b shows a wearer of another embodiment of the temple end-piece of the present invention.

FIG. 7a is a drawing showing an embodiment for connecting a temple to a spectacle frame.

FIG. 7b is an enlarged portion of FIG. 7a.

FIG. 8 is an embodiment of the invention showing an attachment of a temple to a rimless lens.

FIG. 9 is another embodiment of the invention showing an attachment of a temple to a rimless lens.

FIG. 10a is a drawing of another embodiment of the temple end-piece of the present invention.

FIG. 10b is an enlarged drawing of the embodiment depicted in FIG. 10a another embodiment of the temple end-piece of the present invention depicting an alternative form of attachment to a temple of a spectacle frame.

FIG. 11a is a drawing of another embodiment of the temple end-piece of the present invention.

FIG. 11b is an enlarged drawing of the embodiment depicted in FIG. 10a another embodiment of the temple end-piece of the present invention depicting an alternative form of attachment to a temple of a spectacle frame.

### DESCRIPTION OF THE PREFERRED EMBODIMENT

The following preferred embodiment as exemplified by the drawings is illustrative of the invention and is not intended to limit the invention as encompassed by the claims of this application. An apparatus and method for providing an innovative temple for a spectacle frame is disclosed herein.

Typically, a spectacle has two temples: a left temple and a right temple. Each temple is a long and relatively straight member that connects to the frame at the bridge-piece, typically (but not always) through some sort of hinge. The temple end-piece is the portion of the temple that wrests on the wearer's ear and (to varying degrees) protrudes over and behind the ear. The temple end-piece assists in weight distribution and in stabilizing the spectacles during physical activity. There are several different temple styles for providing varying levels of comfort, fit, convenience, and attractiveness. A temple “stem” refers to the body of the temple that attaches to the frame front directly or indirectly. The temple “end piece” refers to the end of the temple stem that fits over and behind ones ear when the eyewear is being worn.

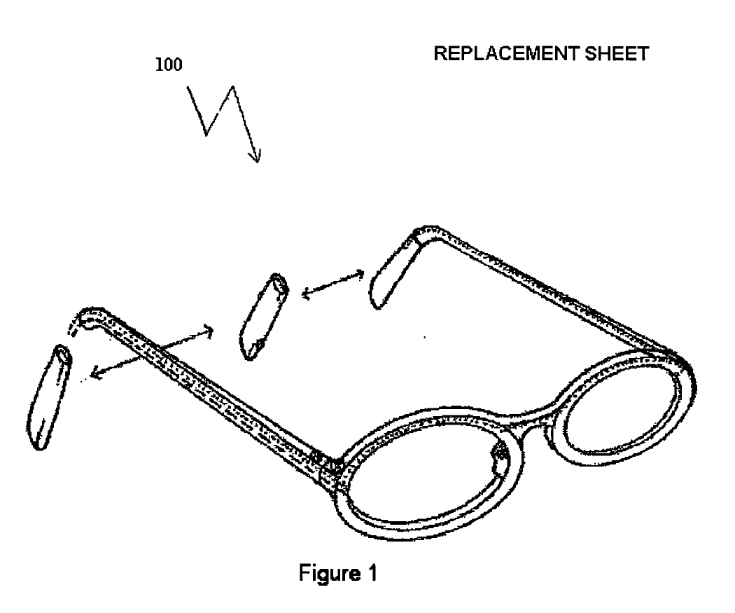

One embodiment of the apparatus of the present invention 100, is illustrated generally in FIG. 1. This embodiment illustrates a universal end-piece (UTEP) for attaching to either temple of an eyeglass frame. A UTEP provides an elegant mechanism and an implementation platform by which highly modular universal temple-end pieces can be attached to and/or detached from the temple stems of compatible eyeglass frames. A UTEP is universal for at least one of the following reasons: 1) Any UTEP can be plugged into any UTEP-compatible frame. UTEP-compatible eyewear would be designed to permit this modularity and standardization. 2) Any UTEP may be plugged into either the left or the right temple thereby providing left-right interchangeability. This invention encompasses a plurality of designs that makes this universality possible.

There are several reasons why UTEP implementation is highly desirable. It is becoming increasingly common for eye wear of all sorts to incorporate batteries, electronics, and other components. Moreover, consumers continue to demand that frames are offered in a wide variety of sizes and styles. Enormous cost savings can be realized when the electronics and other components are housed within standardized UTEPs. This permits the affordable mass production of UTEPs that are compatible with an assortment of different frames. It is also desirable to discreetly house these often heavy or unsightly components on the over-and-behind-the-ear portion of the frame (where the UTEP typically lies) rather than on another frame-based location. There are several consumer conveniences associated with UTEP implementation, particularly if the UTEP contains a battery. UTEP implementation also provides the opportunity for upgradeability and the ability for the wearer to accessorize and customize his eyewear. The size and length of a UTEP should preferably be of sufficient dimensions to allow for this. To achieve left-right independence, any buttons, indicators, and/or other components that may be placed on the UTEP should be designed and positioned so that they are properly placed for use regardless of the temple side to which the UTEP is affixed.

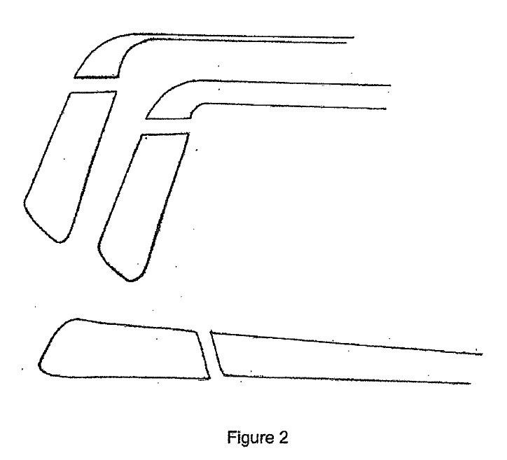

FIG. 2 illustrates a zone of convergence for allowing a frame of any style (e.g. zyle, thick wire, thin wire) to blend or converge to the universal port to aesthetically accommodate a standardized UTEP. This aspect of the invention gives the frame designer significant flexibility by permitting him to use a UTEP without sacrificing aesthetics. The blending of the UTEP with the end tip of the temple may involve the use of varying colors, textures, dimensions, and/or materials.

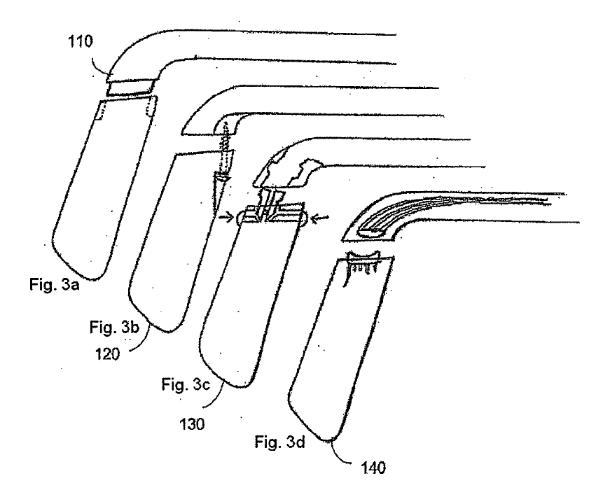

The UTEP contemplated herein may be typically used with non-electrical eyewear (e.g. conventional prescription glasses) because the universal port connection may be entirely physical and mechanical. Examples of such a physical connection may include a wide variety of attachment devices as shown, by way of example, in FIGS. 3a-3d.

For example, a simple snap 110 as shown in FIG. 3a. FIG. 3b illustrates a semi-permanent attachment, in this specific example, using a screw 120. FIG. 3c depicts an attachment that uses a squeezing mechanism for easy attachment and detachment. In this specific example, a push button is shown for attachment and detachment. FIG. 3d illustrates a further example by which a UTEP may be attached to a temple of an eyeglass frame. In this example, a semi-permanent adhesive may be used. Alternatively, and/or in conjunction with any of the following examples, a magnetic attachment 140 may be used. Any of the following attachments may be used with multiple electrical contacts or ports as is also shown in FIG. 3d.

When a UTEP is used with electrical eyewear (e.g. eyewear with electro-active lenses), the universal port connection may be typically both physical and electrical. Some examples of an electrical connection may include simple electrical nodes that come into contact (as shown in FIG. 3d), male-female electrical connections, and other common methods of adjoining electrical nodes as is well known to those skilled in the art. An electrical port may allow the UTEP to communicate with and share electrical power with various components of the glasses via a wire-bundle that may run through the frame as shown in FIG. 1. The wire bundle from the left universal port might, in some instances, traverse the entire length of the glasses and connect with the wire bundle emanating from the right universal port. In other embodiments, it might be desirable to have the left wire bundle terminate at some point before it encounters the right wire bundle.

Typically, when a UTEP is used with electrical or electro-active eyewear, the preferred embodiment of this invention places the core electrical components (e.g. battery, controller, charger port, and the like) within the UTEP housing. Of course, in other inventive embodiments, some or all of these core electrical components may be alternatively placed elsewhere on the frame. If the battery and core electronics are housed within the UTEP, affordable mass production of the complicated electrical components may be realized while preserving significant flexibility to the design contemplated by the frame designer.

By housing the battery and core components within the UTEP several key benefits may be afforded the consumer. For example, the relatively heavy components of electrical eyewear may be located in the over-and-behind-the-ear portion of the frame. This not only allows for these components (e.g. battery, buttons, LEDs) to be discreetly located, it also positions them in such a way that their added weight is borne by the ear rather than by the nose. Another advantage of housing the core electrical components in the UTEP itself is that this permits a family or a group of users who all use UTEP-enabled eyeglass to share chargers, and/or batteries, and/or spare batteries for additional UTEPs. Understanding that modern batteries inevitably weaken over time, further advantages of UTEP standardization ensures that a user can purchase a replacement battery without worrying about compatibility issues. For example, if a superior electrical component or battery becomes available and affordable (e.g. thin film or fuel cell batteries), an upgrade could be made available to the user by providing an updated UTEP. A still further advantage may be that if a core electrical component fails, this would only necessitate in the replacement or repair of just the UTEP, instead of replacing the entire eyeglass frame.

When a UTEP is used, it may be used with a mechanism that recognizes the presence of an attached UTEP. Such recognition of one to another may include negotiation of an appropriate master-slave relationship. If all core components and power sources are located in two identical left-right interchangeable UTEPs, it is likely that this will lead to redundancy of components (e.g. more than one tilt-switch, battery, microchip). In some of such instances, it may be necessary for one of the duplicate component pairs to deactivate itself and yield to the master component. This master-slave relationship could be predetermined; for example, the left UTEP may always act as the master UTEP. Such UTEP “self awareness” may be made possible by using different wiring and circuitry in the left temple than in the right temple. This would alert a UTEP inserted onto the left temple that it is to behave as a left UTEP, and so forth. An alternative example by which a master-slave relationship by be achieved when using UTEPs with redundant components may be without sensing their position on the frame via some frame-based cue. For example, by having the logic of each UTEP generate a random number. In this way, the UTEP that generated the lowest number could act as a master; if identical numbers were generated, the process would repeat. Another example may be to simply assign the maser-slave relationship based on uniquely embedded serial numbers associated with every UTEP during the manufacturing process. A further example may be to assign the master title to the UTEP that happened to have the highest battery capacity. These are several of the many ways known to those skilled in the art by which “frame-independent self-awareness” could be achieved. All such methods and devices fall under the scope of this invention.

Once the master-slave relationship has been negotiated and determined, it is a preferred embodiment of this invention to ensure that the battery within one of the UTEPs completely discharges before the other UTEP battery begins to discharge. Such a sequential rather than simultaneous discharging provides the wearer with an enormous convenience. If the wearer happens to have a spare UTEP-battery, he can wait for one of the UTEPs to fully discharge and place the fully charged spare in its place thereby yielding eyewear with two fully charged UTEPs.

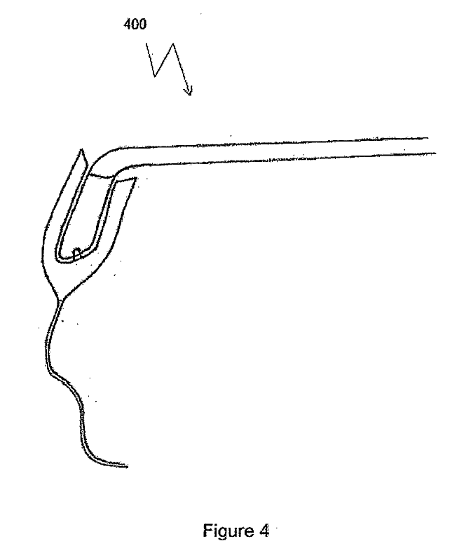

FIG. 4 illustrates a sleeve-style battery charger that makes electrical contact with only one UTEP. Examples how such a contact may be made include using simple electrical nodes that come into contact with mating electrical contacts or any other common methods of adjoining electrical nodes as is well known to those skilled in the art. The charger depicted in FIG. 4 may be preferably used for charging both the left and the right UTEP batteries simultaneously even if the charger is only attached to one of them. This may be accomplished by having circuitry and/or conducting material traversing the entire length of the spectacle frame. The charger depicted in FIG. 4 may also be preferably used for charging an unattached spare UTEP-battery. The UTEP needn't be attached to the frame in order to charge it.

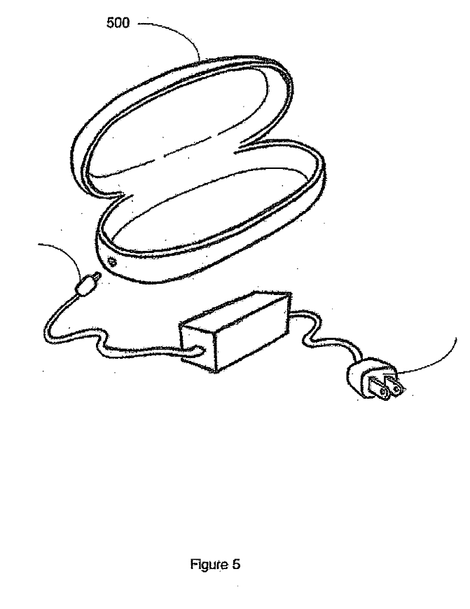

As shown in FIG. 5, the sleeve-charger may also be incorporated into an eyeglass case, a cradle, or a docking station.

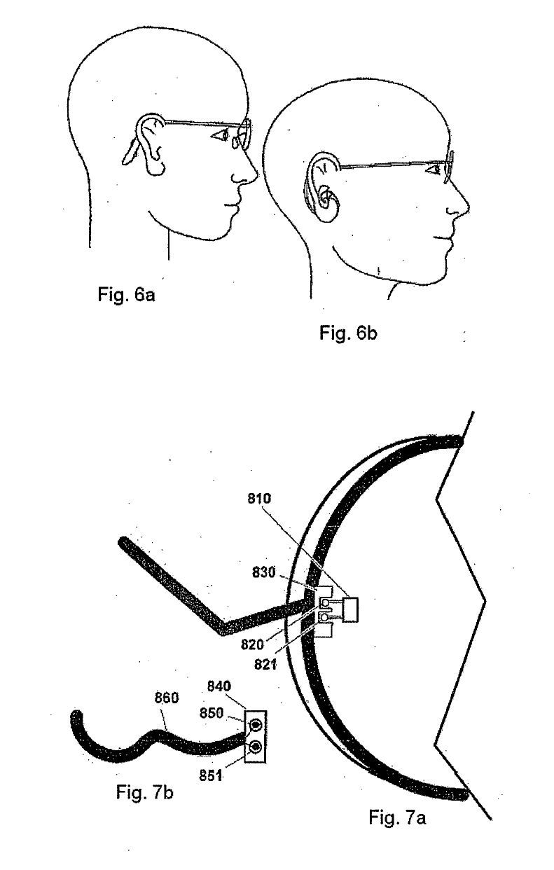

FIGS. 6a and 6b show a UTEP on the wearer of with non-electrical eyewear (e.g. typical prescription eyeglasses). The production and use of UTEP accessories may accommodate both the short-term and long-term needs of the wearer. Instances may arise (for example, during periods of physical activity) when the wearer desires for his frames to be “sportier” or to have temple end-pieces that provide a tighter fit. Such alternative designs of UTEPs are shown by way of example in FIG. 6b. Such an implementation permits the user to easily attach more “sporty” UTEPs as needed instead of purchasing and carrying a second pair of sporty eyeglasses. Another example of how a UTEP may provide for additional levels of accessories to the wearer may be to attach a UTEP of a different shape, style, color, or material for fashion reasons, perhaps to match clothing or as a form of individual expression.

Using a UTEP may afford still further electronic accessories to be included with eyewear including: hands-free Bluetooth accessories for mobile phones, mp3/audio players, anti-noise ear buds, alarms, heart-rate monitors, frame heaters, and wireless transponders permitting communication between the eyewear and computers, personal digital assistants, and wireless networks. Further optional UTEP accessories may, for example, accept disposable batteries. Still further optional UTEP accessories may allow the user to select a button-controlled UTEP, a rum-dial controlled UTEP, a remote controlled UTEP, a heat-activated-button controlled UTEP, among other examples. The UTEP implementation allows the consumer the freedom to decide how to control and interact with his electronic eyewear. Any and all of the aforementioned additional accessories may be attached by means of a docking station located on the UTEP itself, on the frame, or attached by means of an additional attachment mechanism.

FIGS. 7a and 7b illustrate a connection mechanism utilizing magnetic attraction. In this case, the controller 810 is electrically connected to two contact points 820, 821 via ultra thin wires or ITO buses. The contact points are surrounded by a tiny steel plate 830 (or other material having good magnetic properties) with small cut-outs to avoid shorting out the two contact points. A tether 860 has a small but powerful magnetic plate 840 attached to its ends. Within the magnetic plate are two holes that contain contact points 850, 851 to the two conductors within the tether. In this manner, the attraction between the steel plate and the magnetic plate force both a physical and an electrical connection between the tether and the lenses. The front side of the magnetic plate may be painted or coated with a finish that is similar to the frame finish so that the connection is cosmetically acceptable to consumers. While this type of connection has been shown at the lens surface, a similar connection can be made at any point on the tether if so desired. Such a connection may also be located on the surface of the frame as opposed to that of the lens, in which case, a further connection may preferably be made to the lens. The magnetic connection may be used exclusively as a mechanical connection to a tether or one that provides electrical communication therebetween, or both. Although the shape is illustrated as rectangular for illustrative purposes, other geometries may be used where appropriate and is considered within the scope of the present invention.

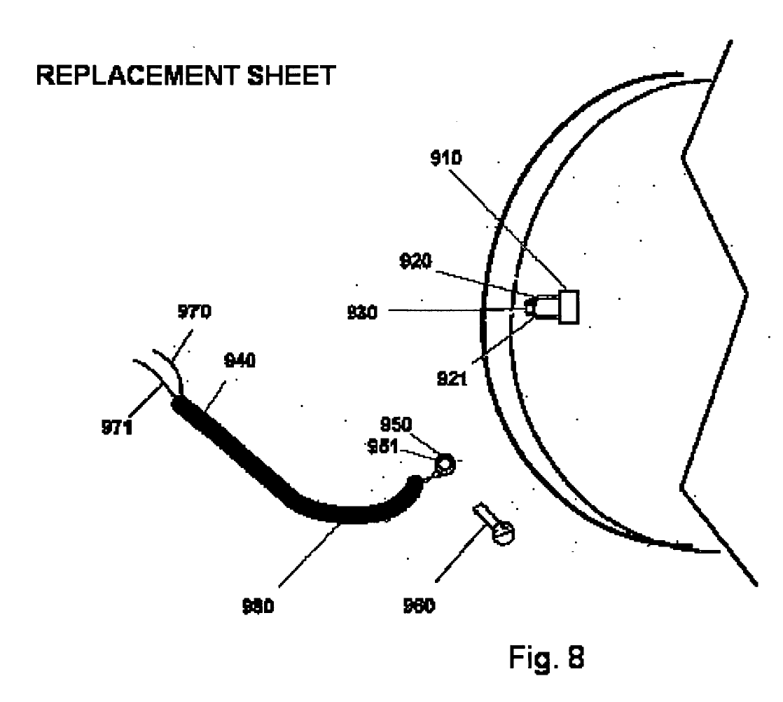

FIG. 8 illustrates an attachment design whereby the temple contains conductive wiring and is designed for a rimless mounting of the lenses. In this case, a controller 910 has contact points 920, 921 that may preferably be semicircular and are located about a through hole 930, which is customarily drilled through the lens for mounting. A temple 940 may preferably have a loop with two conductive contact rings 950, 951 for attaching to each of the two conductive wires 970, 971 within the temple. A bolt 960 may be used to hold the lens to the temple 980 of a rimless or hingeless frame. Such a rimless frame is typically made of high strength metals, such as titanium (which is widely used in the fabrication of rimless frames) and making the electrical connection therewith. The hole in the lens may be tapped with threads so that a screw may be used or a nut (not shown) may be screwed to the protruding end of a bolt for fastening. In such an example, it may be possible to conduct electricity over the full or partial length of the temple to the lens without having any connections at or through the frame hinges, since no hinges may be used needed.

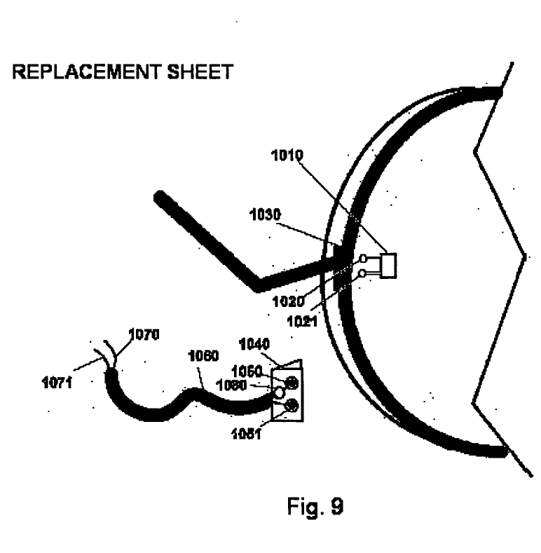

FIG. 9 illustrates the attachment of the tether using a clamp. The controller 1010 has contact points on the lens 1020, 1021 near a flange 1030 on the outer perimeter of the frame. The tether 1060 has a clamp 1040 (in this example, a v-shaped clamp is used but any other design may be used) that contains two conductive contact points 1050, 1051 for providing power to the lens when the tether is in place. Additionally, a tilt switch 1080 may be used to break the electrical connection from one of the two conductive wires 1070, 1071 as part of a control mechanism for electro-active lenses, for example, for correcting presbyopia.

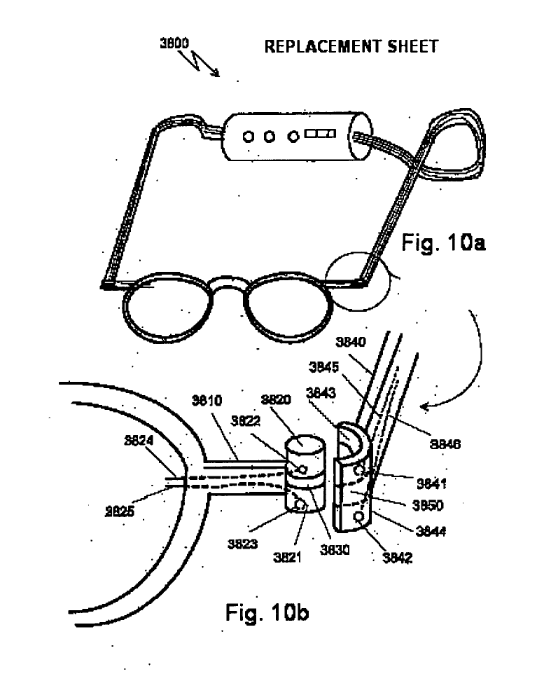

FIGS. 10a and 10b illustrate another embodiment of the present invention showing a break-away magnetic hinge. Active individuals such as athletes and children will benefit greatly by having eyewear with breakaway hinges. Further, this embodiment solves a nuisance that has been prevalent within the optical industry for decades, that being hinge screws that come loose or fall out. Break away hinges solves this historical problem by omitting the hinge screw and replacing it with a magnet.

Typically, the break away magnetic hinge should have electrical contacts. A frame 3810 is shown which contains two magnets 3820 and 3821 that are electrically isolated from one another with an insulating ring or cylinder 3830 therebetween. Contact points 3822 and 3823 are on or within each magnet for providing contact with wires 3824 and 3825 for powering an electro-active lens that may reside in the frame. (The frame side for a patient's right eye is illustrated). The temple side of the frame 3840 includes contact points 3841 and 3842 to metallic and or magnetic surfaces 3843 and 3844, which are also electrically insulated from one another by an insulating ring 3850 therebetween. The two contact points 3841 and 3842 are for providing electrical contact with wires 3845 and 3846 that run through the frame stem to the power supply and/or to a controller typically attached to the back of the frame tether. This embodiment of the present invention allows an electrical connection to be made through a frame hinge without actually running wires through the frame hinge. It also allows one to separate the frame from the temple for placing the frame and frame tether over one's head. In practice, the break-away magnetic frame hinge may be placed on either both sides of the frame or on just one side of the frame. In the cases where the break-away magnetic frame hinge is used on just one side of the frame, the other side of the frame may include either a conventional frame hinge or no frame hinge.

This inventive embodiment allows the wearer to simply detach the frame front from their eyewear and then connect the two stems containing magnets together, thus forming a necklace with a magnetic closure. This can be done while maintaining the functionality of the electronic tether. In other words, while the electronic tether and stems are typically connected by a magnetic closure, the electronic tether together with the stems become a necklace and can be used to play audio to the wearer. By way of example only, an MP3 player could remain functioning and using the adjustable ear speakers or ear phones and one may adjust for more speaker wire and thus utilize speakers in each ear while wearing the magnetically closed necklace. It should be pointed out that that the magnets can be used in any manner to accomplish this embodiment. By way of example only, a single hinge magnet can be used on each stem or one hinge magnet can be used on the stem and one on the opposite frame front where the other hinge connects, etc. It is further contemplated that the two magnetic ends of the tether may be attached to an independent locket that would be attachable and detachable to each of the two magnetic ends, thus dressing up the necklace.

While the break-away magnetic frame hinge has been illustrated in FIGS. 10a and 10b showing electrical connectivity, it is to be understood that a break-away magnetic frame hinge may also be used for non-powered lenses. As such, they would only typically require a single magnet on either the frame or the temple (or on both sides) of the frame hinge. Alternatively, electrical connections could be made without using the magnets as electrical contacts. In such an embodiment, a single magnet may be placed on either the frame or on the temple side of the hinge and may be used as long as the electrical contacts are properly insulated from one another.

FIG. 10a illustrates the placement of the magnet on the temple and the metal hinge piece on the frame front wherein a cylinder shaped magnet 3875 is placed on the frame stem temple 3840 instead of the frame 3810. In this case, a hollow cylinder 3870 with an internal metallic surface that is attracted to the cylinder shaped magnet 3875 is placed on the frame. This is also illustrated without electrical conductive wires, since applications for such a breakaway frame hinge exist where no electrical power is used. It should be pointed out that both the cylinder shaped magnet 3875 and the hollow cylinder may be made of magnetic materials. Alternatively, only one piece need be magnetic as long as the other is made from a metal that can be magnetized and thus attracted by a magnet, for example ferrous metals, such steel or iron. Although the preferred shape of the magnet is cylindrical as shown, it could be of any shape that would provide the needed functionality.

As more particularly shown in FIG. 10a, an electronic tether may be used in association with a frame having two breakaway magnetic hinges, one for each side of the frame front. In this embodiment, the magnets may be located on the breakaway stems and the electronic tether may be connected to the rear of each stem. It should be pointed out that the magnet breakaway hinge could be used for either electronic eyewear or non-electronic eyewear.

Finally, it should be pointed out that the structure to which the magnet of a magnetic hinge is attracted or attached to can be of any shape to provide the proper functionality. By way of example only, it can be an open cylinder as shown in FIG. 10b, or it may be a closed cylinder having both ends open, one open and the other closed. The magnet can be housed within a structure to hide or dress up the magnet. The structure, by way of example only, could simply be a metal facade that is around the magnet, thus hiding the magnet but allowing for the magnetic affect to still contribute the proper functionality needed for a magnetic hinge.

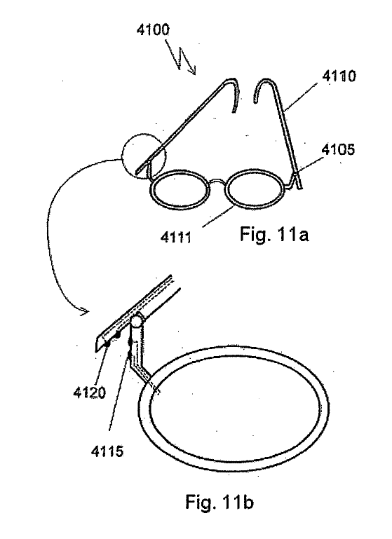

FIGS. 11a and 11b illustrate an embodiment whereby a pair of spectacles 4100 powers electro-active lenses without requiring electrical conductors through the frame hinge. This is accomplished by locating the frame hinge 4105 a short distance from the end of the frame temple 4110. The hinge location may be any reasonable distance from the end of the frame temple, but may have a preferred range of from about 0.1 to about 1.0 inches, with a most preferred range of from about 0.25 to about 0.5 inches from the end of the frame temple. Electrical contact points 4115 may be located on the front of the frame 4111. When the frame is fully opened, these contact points make electrical contact with the contact points 4120 on the very end frame temple 4110. In this way, the opening and the closing of the frame may act as a power switch for applying and removing power to either the lenses or to the electronics (not shown) or both which may either be built into the lenses or the frame front or both. Although a pair of electrical contact points is illustrated, it is to be understood that multiple contact points may be required for certain applications. Alternatively, some embodiments may only require a single contact point in each or in either temple. For example, in certain embodiments a conductor may be housed in each temple of a frame where each temple provides a single power terminal connection to the electronics and or lenses in the frame. In any case, having either fewer contacts or more contacts are to be considered within the scope of the present invention.

Although the particular embodiments shown and described above will prove to be useful in many applications in the optical art to which the present invention pertains, further modifications of the present invention will occur to persons skilled in the art. All such modifications are deemed to be within the scope and spirit of the present invention as defined by the appended claims.

What is claimed is:

1. An end-piece for a temple of an eyeglass frame, wherein the end-piece is adapted for attaching to either the right temple or the left temple of the eyeglass frame, comprising:
a. an attachment device for detachably attaching the end-piece to the temple of the eyeglass frame; and
b. an electronic component housed therein.

2. The end-piece of claim 1, wherein said attachment device includes a snap-on device.

3. The end-piece of claim 1, wherein said attachment device includes a screw.

4. The end-piece of claim 1, wherein said attachment device includes a squeezing device for detachably attaching the end-piece to the temple.

5. The end-piece of claim 1, wherein said attachment device includes a magnet.

6. The end-piece of claim 1, wherein said electronic component includes a power source.

7. The end-piece of claim 1, wherein said electronic component includes a tilt switch.

8. The end-piece of claim 1, wherein said electronic component includes a listening device.

9. The end-piece of claim 1, wherein said electronic component includes a docking station for an additional electronic component.

10. The end-piece of claim 1, wherein said electronic component includes a charging device.

11. The end-piece of claim 11, wherein said charging device is adapted for directly coupling to an energy source.

12. The end-piece of claim 11, wherein said charging device is adapted for indirectly coupling to an energy source.

13. The end-piece of claim 1, wherein said temple is adapted for providing an electrical connection with the frame only when the frame is opened.

14. The end-piece of claim 1, wherein the end piece is capable of attaching to a plurality of different temples each capable of receiving the end-piece.

15. The end-piece of claim 1, wherein the frame houses an electro-active lens.

16. The end-piece of claim 1, wherein the frame houses a lens capable of having its tint altered by electrical power.
